(19) United States
(12) Patent Application Publication
(10) Pub. No.: US 2005/0057784 A1
(43) Pub. Date: Mar. 17, 2005

(54) [OPTICAL SCANNING MODULE]

(76) Inventors: Chuan-Yu Hsu, Hsinchu City (TW); Jen-Shou Tseng, Miao-Li Hsien (TW); Tse-Hui Pang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,164

(22) Filed: Sep. 12, 2003

(51) Int. Cl. H04N 1/04; H04N 1/46

(52) U.S. Cl. 358/474; 358/509

(57) ABSTRACT

An optical scanning module comprising an outer cover, a plurality of fixing elements, a plurality of reflecting mirrors, a plurality of buffer pads, a lens, an image capturing device and a light source is provided. Each of the fixing elements disposed on the inner wall of outer cover comprises a clip and a reflecting mirror supporting holder. The reflecting mirror supporting holder is manufactured as an integrative unit on the inner wall of the outer cover. The clip has a crooked portion that holds the reflecting mirror and the buffer pads on the reflecting mirror supporting holder. Further, when the reflecting mirror is fixed on the reflecting mirror supporting holder by the clip, the buffer pads are set between the mirrors and the holders. Therefore, the bending or the curling phenomenon of reflecting mirrors and the distortion of image quality can be effectively prevented.

### BACKGROUND OF INVENTION

1. Field of the Invention

The present invention relates to an optical scanning module, and more particularly, to an optical scanning module that effectively resolves the bending phenomenon of the reflecting mirrors.

2. Description of the Related Art

Recently, along with the great progress of the computer performance and the highly developed of the multimedia technique. Besides using the digital camera (DC) to directly extract the analog image light and correspondingly producing the digital image signal, any other image input operations related to documents and pictures has to extract the analog image light by using an optical scanner or other image reading device with similar function, and converts the analog image light into a digital image signal, so as to facilitate the user on the operations such as the displaying, optical character recognition (OCR), editing, storing, and printing the digital image files on the computer equipment or other related electronic products. Since the optical scanner is very expensive, it almost only serves for the professional workers such as the art workers before. Recently, thanks to the great progress of the computer techniques and low price due to the intensive competition on the optical scanner market, it has finally become a mainstream in the personal computer world, and has become a major component of the computer peripheral device.

The optical scanner is classified into various types according to its price and functions. Basically, the general scanner is roughly classified into following categories: the hand-held optical scanner, the paper-fed optical scanner, the business-card-size optical scanner, the film optical scanner, and the flat-bed optical scanner. Wherein, the flat-bed optical scanner is like a glass platform, which places the document or picture on a flat glass, and reads the data by moving the optical scanning module. Since its structure is not too complicated and the usage is not too difficult, and plus its high function expandability, it has become the mainstream for the computer users to adapt with the optical scanner now.

FIG. 1 is a schematic side sectional view of a conventional optical scanning module. Referring to FIG. 1, the optical scanning module 100 comprises an outer cover 110, a plurality of fixing elements 120, a plurality of reflecting mirrors 130, a lens 150, an image capturing device 160, and a light source 170. Each of the fixing elements 120 is composed of a reflecting mirror supporting holder 122 and a clip 124. Inside the conventional optical scanning module 100, the reflecting mirrors 130 are clapped on the reflecting mirror supporting holder 122 by using the clap 124, and the reflecting mirror supporting holder 122 is manufactured as an integrative unit on the outer cover 110.

FIG. 2A is a schematic view illustrating the contact status of a conventional clip and a reflecting mirror, and FIG. 2B is a schematic sectional view illustrating a conventional clip clipping the reflecting mirror supporting holder and the reflecting mirror. Referring to both FIG. 2A and FIG. 2B, the clip 124 is directly contacted with the reflecting mirror 130 via a crooked portion 124a. When the crooked portion 124a on the clip 124 is contacted with the reflecting mirror 130, the reflecting mirror 130 suffers a moment effect and occurs a bending phenomenon, thus causes a flatness variance on the reflecting mirror 130, which further impacts the preciseness of the extracted signal extracted by the image capturing device, and finally causes a problem of distortion of image quality. In order to solve the commonly occuring defect mentioned above, the size tolerance when manufacturing the clip 124 is extremely critical, thus inevitably increases the manufacturing cost.

### SUMMARY OF INVENTION

In the light of the above problems, it is a primary object of the present invention to provide an optical scanning module comprising an elastomeric and soft buffer pad in between the reflecting mirror and the clip for effectively preventing the bending phenomenon of reflecting mirrors and the distortion of image quality due to the clip, and the cost incurring from manufacturing the clip with great precision for improving such defect can be effectively avoided.

In order to achieve the object mentioned above, the present invention provide an optical scanning module. The optical scanning module comprises an outer cover, a plurality fixing elements, a plurality of reflecting mirrors, a plurality of buffer pads, a lens, an image capturing device, and a light source. The outer cover has an opening, and the fixing elements are disposed on the inner wall of the outer cover. The lens and the image capturing device are disposed on the certain locations inside the outer cover, and the light source is disposed on the outer cover. In the present embodiment, the light emitted by the light source is reflected by the document being scanned, and the reflected light is sequentially transmitted to the reflecting mirrors, the lens and the image capturing device via the opening on the outer cover.

With the same reason as mentioned above, the present invention further provides an optical scanning module. The optical scanning module comprises an outer cover, a plurality fixing elements, a plurality of reflecting mirrors, a plurality of buffer pads, a lens, an image capturing device, and a light source. The outer cover has an opening, and the fixing elements are disposed on the inner wall of the outer cover. The reflecting mirrors are collectively held by the clip and the reflecting mirror supporting holder, and the buffer pads are disposed in between the clip and the reflecting mirrors. The lens and the image capturing device are disposed on the appropriate locations inside the outer cover, and the light source is disposed on the outer cover. In the present embodiment, the light emitted by the light source is reflected by the document being scanned, and the reflected light is sequentially transmitted to the reflecting mirrors, the lens, and the image capturing device via the opening on the outer cover.

In the present embodiment, the fixing element is composed of a clip and a reflecting mirror supporting holder. The reflecting mirror supporting holder is integrally formed on the inner wall of the outer cover. The clip is used to clip the reflecting mirror and the buffer pad on the reflecting mirror supporting holder, and the buffer pad is disposed in between the clip and the reflecting mirror.

Further, the buffer pad is made of a material such as silicone, sponge, or other elastomeric material having elastic and or resilient characteristics, the image capturing device is comprised of, for example, a charge couple device (CCD), and the light source is comprised of, for example, a cold cathode florescent lamp (CCFL) or a light emitting diode array.

Following the description above, since the buffer pad disposed in between the clip and the reflecting mirror is characterized by its resilience and elasticity, the stress applied on the reflecting mirror by the clip can be minimal so as to avoid the occurrence bending or curling phenomenon on the reflecting mirror, such that the reflecting mirror can maintain its optimal flatness. Further, the size tolerance of the clip also can be enlarged. Thus the cost incurring from manufacturing the clip with great precision can be effectively avoided.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic side sectional view of a conventional optical scanning module.

FIG. 2A is a schematic view illustrating the contact status of a conventional clip and a reflecting mirror.

FIG. 2B is a schematic sectional view illustrating a conventional clip clipping the reflecting mirror supporting holder and the reflecting mirror.

FIG. 3 is a schematic side sectional view of an optical scanning module according to a first preferred embodiment of the present invention.

FIG. 4 is a schematic top view illustrating a clip clipping the reflecting mirror supporting holder and the reflecting mirror according the first preferred embodiment of the present invention.

FIG. 5A is a schematic sectional view illustrating a clip clipping the reflecting mirror supporting holder and the reflecting mirror according to the first preferred embodiment of the present invention.

FIG. 5B is another schematic sectional view illustrating a clip clipping the reflecting mirror supporting holder and the reflecting mirror according to the first preferred embodiment of the present invention.

FIG. 6 is a schematic sectional view illustrating a clip clipping the reflecting mirror supporting holder and the reflecting mirror according to a second preferred embodiment of the present invention.

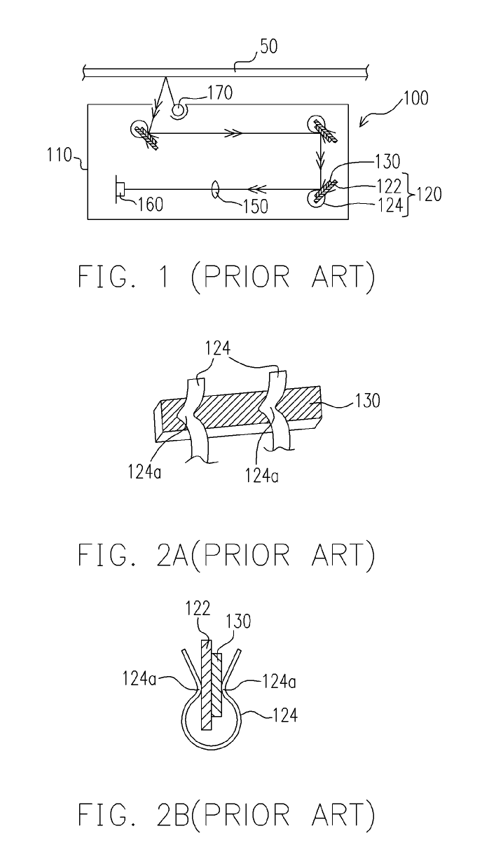

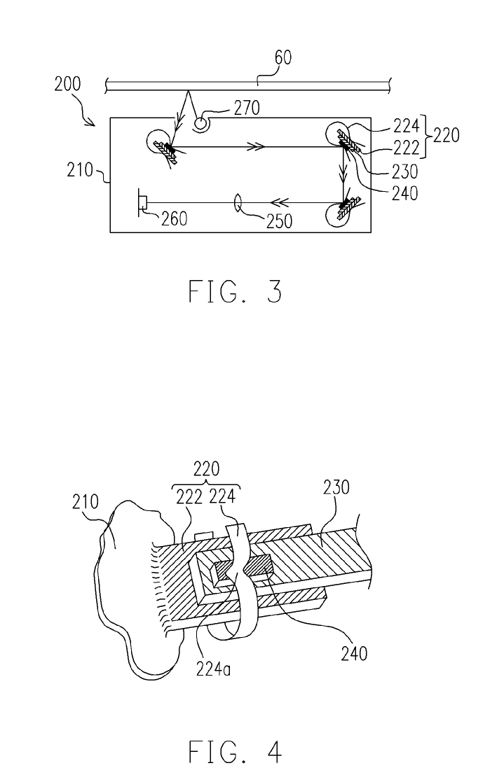

### DETAILED DESCRIPTION

### FIRST EMBODIMENT

FIG. 3 is a schematic side sectional view of an optical scanning module according to a first preferred embodiment of the present invention. Referring to FIG. 3, the optical scanning module 200 comprises an outer cover 210, a plurality of fixing elements 220, a plurality of reflecting mirrors 230, a plurality of buffer pads 240, a lens 250, an image capturing device 260, and a light source 270. The outer cover 210 has an opening, and the lens 250 is disposed within the outer cover 210. The image capturing device 260 is disposed within the outer cover 210, and the light source 270 is disposed on the outer cover 210. The light emitted by the light source 270 is reflected by the document 60 being scanned, and the reflected light is sequentially transmitted to the reflecting mirrors 230, the lens 250 and the image capturing device 260 via the opening on the outer cover 210.

FIG. 4 is a schematic top view illustrating a clip clipping the reflecting mirror supporting holder and the reflecting mirror according to the first preferred embodiment of the present invention. Referring to FIG. 4, the fixing element 220 is disposed on the inner wall of the outer cover 210, and the fixing element 220 is composed of a reflecting mirror supporting holder 222 and a clip 224. The reflecting mirror supporting holder 222 is integrally formed on the inner wall of the outer cover 210. The clip has a crooked portion 224a for collectively clipping the buffer pad 240, the reflecting mirror 230 and the reflecting mirror supporting holder 222.

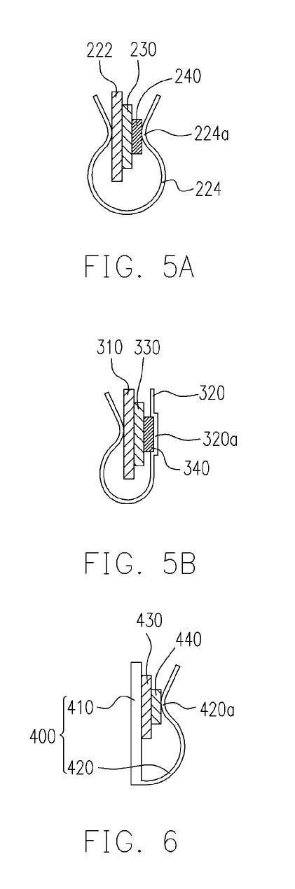

FIG. 5A is a schematic sectional view illustrating a clip clipping the reflecting mirror supporting holder and the reflecting mirror according to the first preferred embodiment of the present invention. Referring to FIG. 5A, the clip 224 has a crooked portion 224a, and the buffer pad 240 is fixed on a convex of the crooked portion 224a using a layer of an adhesive. The clip 224 clips the reflecting mirror 230 and the reflecting mirror supporting holder 222, and the buffer pad 240 is disposed in between the clip 224 and the reflecting mirror 230. Since the buffer pad 240 is resilient and elastic, the stress applied on the reflecting mirror 230 by the clip 224 can be minimal so as to avoid the occurrence of bending or curling phenomenon on the reflecting mirror 230 can be effectively prevented. Thus, the reflecting mirror 230 can maintain its optimal flatness.

FIG. 5B is another schematic sectional view illustrating a clip clipping the reflecting mirror supporting holder and the reflecting mirror according to the first preferred embodiment of the present invention. Referring to FIG. 5B, the clip 320 has a crooked portion 320a, and the buffer pad 340 is fixed on a concave of the crooked portion 320a using a layer of an adhesive. Similarly, since the buffer pad 340 is resilient and elastic, the stress applied on the reflecting mirror 330 by the clip 320 can be minimal, so that the reflecting mirror 330 can maintain its optimal flatness.

### SECOND EMBODIMENT

In the optical scanning module according to a second preferred embodiment of the present invention, the major difference compared to the first preferred embodiment is in its fixing elements, and the detail descriptions of other similar elements are omitted herein. FIG. 6 is a schematic sectional view illustrating a clip clipping the reflecting mirror supporting holder and the reflecting mirror according to the second preferred embodiment of the present invention. Referring to FIG. 6, the fixing element 400 comprises a reflecting mirror supporting holder 410 and a clip 420 disposed on the reflecting mirror supporting holder 410. The clip 420 can be integrally formed or alternatively the clip 420 can be separate element which can be fixed on the reflecting mirror supporting holder 410 by using screws. The clip 420 has a crooked portion 420a, and the reflecting mirror 430 is collectively held by the crooked portion 420a of the clip 420 and the reflecting mirror supporting holder 410.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. An optical scanning module suitable for scanning a document, comprising:
an outer cover, having an opening;
a plurality of fixing elements, disposed on an inner wall of the outer cover;
a plurality of reflecting mirrors, disposed within the outer cover by using the fixing elements;
a plurality of buffer pads, disposed in between the fixing elements and the reflecting mirrors;
a lens, disposed within the outer cover;
an image capturing device, disposed within the outer cover; and
a light source, disposed on the outer cover, wherein a light emitted by the light source is reflected by the document, and the reflected light is sequentially transmitted to the reflecting mirrors, the lens, and the image capturing device.

2. The optical scanning module of claim 1, wherein each of the fixing elements comprises:
a reflecting mirror supporting holder; and
a clip for clipping the reflecting mirrors and the buffer pads on the reflecting mirror supporting holder.

3. The optical scanning module of claim 2, wherein the clip has a crooked portion for fastening the buffer pads.

4. The optical scanning module of claim 2, wherein the reflecting mirror supporting holder is manufactured as an integrative unit on the inner wall of the outer cover.

5. The optical scanning module of claim 1, wherein each of the fixing elements comprises:
a reflecting mirror supporting holder; and
a clip disposed on the reflecting mirror supporting holder for clipping the reflecting mirrors and the buffer pads together with the reflecting mirror supporting holder.

6. The optical scanning module of claim 5, wherein the clip has a crooked portion for fastening the buffer pads.

7. The optical scanning module of claim 5, wherein the reflecting mirror supporting holder and the clip are manufactured as an integrative unit on the inner wall of the outer cover.

8. The optical scanning module of claim 1, wherein the buffer pads are made of a material comprising either a silicone or a sponge.

9. The optical scanning module of claim 1, wherein the image capturing device comprises a charge couple device (CCD).

10. The optical scanning module of claim 1, wherein the light source comprises a cold cathode florescent lamp (CCFL) and a light emitting diode array.
